(19) United States
(12) Patent Application Publication
(10) Pub. No.: US 2024/0097180 A1
(43) Pub. Date: Mar. 21, 2024

(54) LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Ryohei TANAKA, Hamamatsu-shi (JP); Naoki WAKAMATSU, Toyohashi-shi (JP); Shunya MARUYAMA, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/370,368

(22) Filed: Sep. 19, 2023

(30) Foreign Application Priority Data
Sep. 21, 2022 (JP) 2022-149998

(51) Int. Cl. H01M 10/0525; H01M 10/0585; H01M 50/491

(52) U.S. Cl. CPC H01M 10/0525; H01M 10/0585; H01M 50/491

(57) ABSTRACT

A lithium-ion rechargeable battery includes a negative electrode plate including a negative electrode substrate and a negative electrode mixture layer applied to the substrate, a positive electrode plate including a positive electrode substrate and a positive electrode mixture layer applied to the substrate, a separator arranged between the negative electrode plate and the positive electrode plate, and a non-aqueous electrolyte. The negative electrode substrate includes a negative electrode connection portion that projects from the negative electrode mixture layer in a first width direction. The positive electrode substrate includes a positive electrode connection portion that projects from the positive electrode mixture layer in a second width direction. The separator has a gas permeability that is greater at a portion facing an end of the positive electrode mixture layer in the second width direction than a portion facing an end of the positive electrode mixture layer in the first width direction.

### BACKGROUND

### 1. Field

The following description relates to a lithium-ion rechargeable battery.

### 2. Description of Related Art

A lithium-ion rechargeable battery includes a negative electrode plate, a positive electrode plate, a separator, and a non-aqueous electrolyte. The negative electrode plate includes a negative electrode substrate and a negative electrode mixture layer applied to the surface of the negative electrode substrate. The positive electrode plate includes a positive electrode substrate and a positive electrode mixture layer applied to the surface of the positive electrode substrate. The separator is arranged between the negative electrode plate and the positive electrode plate.

One type of such a lithium-ion rechargeable battery includes a separator of which the breathability varies between different portions (refer to, for example, Japanese Laid-Open Patent Publication No. 2019-21394). The separator includes a first separator portion, arranged between the positive electrode mixture layer and the negative electrode mixture layer, and a second separator portion, arranged between the negative electrode mixture layer and a part of the positive electrode substrate that is free from the positive electrode mixture layer. The breathability of the second separator portion is less than that of the first separator portion. In such a lithium-ion rechargeable battery, the second separator portion, the breathability of which is low, reduces the passage of aluminum ions, thereby minimizing the amount of aluminum deposited from the positive electrode substrate on the negative electrode mixture layer.

In the lithium-ion rechargeable battery described above, the first separator portion arranged between the positive electrode mixture layer and the negative electrode mixture layer has a high breathability and thus increases the replenished amount of the non-aqueous electrolyte. As a result, the movement of lithium ions will be concentrated at positions corresponding to the ends of the positive electrode mixture layer in the width direction, and metal may be eluted from the positive electrode mixture layer. In such a case, the metal will be deposited on the negative electrode mixture layer at a position facing an end of the positive electrode mixture layer in the width direction. This may adversely affect, for example, the input/output properties of the lithium-ion rechargeable battery. The deposition of metal on the negative electrode mixture layer may be reduced by, for example, by controlling the input current. This will, however, impose a limitation on the input performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lithium-ion rechargeable battery includes a negative electrode plate including a negative electrode substrate and a negative electrode mixture layer applied to a surface of the negative electrode substrate, a positive electrode plate including a positive electrode substrate and a positive electrode mixture layer applied to a surface of the positive electrode substrate, a separator arranged between the negative electrode plate and the positive electrode plate, and a non-aqueous electrolyte. The negative electrode substrate includes a negative electrode connection portion that projects from the negative electrode mixture layer in a first width direction and is electrically connected to a negative electrode external terminal. The positive electrode substrate includes a positive electrode connection portion that projects from the positive electrode mixture layer in a second width direction opposite to the first width direction and is electrically connected to a positive electrode external terminal. The separator has a gas permeability that is greater at a portion facing an end of the positive electrode mixture layer in the second width direction than a portion facing an end of the positive electrode mixture layer in the first width direction.

In another general aspect, in the above lithium-ion rechargeable battery, the gas permeability of the separator may increase in the second width direction.

In another general aspect, in the above lithium-ion rechargeable battery, the gas permeability of the separator at the end in the second width direction may be 105% or greater with respect to the gas permeability at the end in the first width direction.

Other features and aspects will be apparent from the following detailed description, the drawings, and the claims.

### BRIEF DESCRIPTION OF THE DRAWINGS

FIG. 1 is a perspective view of a lithium-ion rechargeable battery in accordance with one embodiment.

FIG. 2 is a diagram showing an electrode body in one embodiment in a partially spread out state.

FIG. 3 is a cross-sectional view showing the configuration of the electrode body in one embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

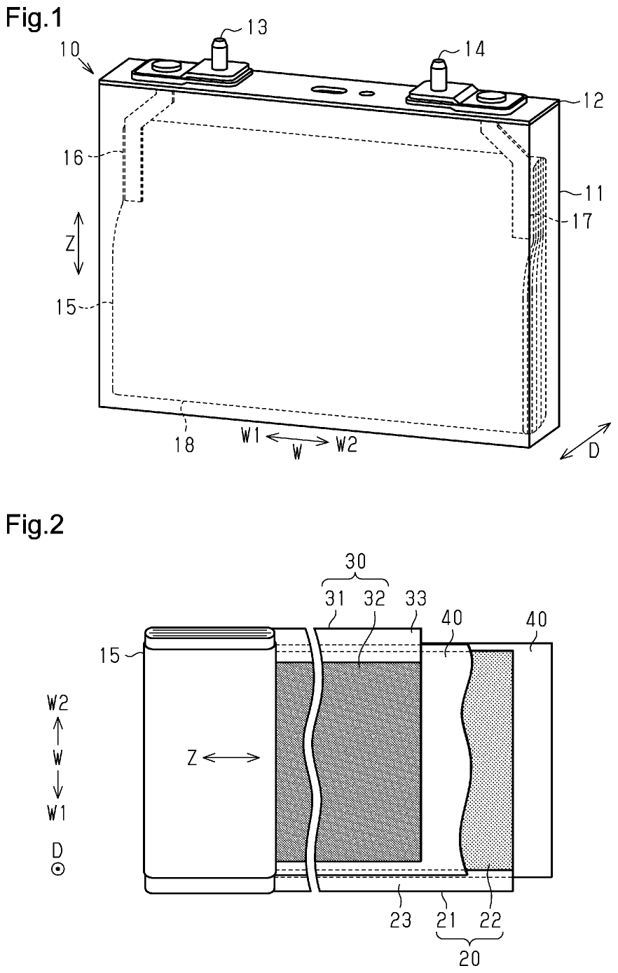

A lithium-ion rechargeable battery 10 according to one embodiment will now be described with reference to FIGS. 1 to 3.

Configuration of Lithium-Ion Rechargeable Battery 10

As shown in FIG. 1, the lithium-ion rechargeable battery 10 forms a cell battery. The lithium-ion rechargeable battery 10 includes a battery case 11 and a lid 12. The battery case 11 has an opening (not shown) at the top side. The lid 12 seals the opening. The battery case 11 is formed from metal such as an aluminum alloy. The lid 12 includes a negative electrode external terminal 13 and a positive electrode external terminal 14 used for charging and discharging power.

The lithium-ion rechargeable battery 10 includes an electrode body 15, a negative electrode current collector 16, and a positive electrode current collector 17. The electrode body 15 is accommodated in the battery case 11. The negative electrode current collector 16 connects the negative electrode of the electrode body 15 to the negative electrode external terminal 13. The positive electrode current collector 17 connects the positive electrode of the electrode body 15 to the positive electrode external terminal 14.

The lithium-ion rechargeable battery 10 includes a non-aqueous electrolyte 18. The non-aqueous electrolyte 18 is injected into the battery case 11. The lithium-ion rechargeable battery 10 forms a sealed battery case when the lid 12 is attached to the battery case 11. In this manner, the battery case 11 accommodates the electrode body 15 and the non-aqueous electrolyte 18.

Electrode Body 15

As shown in FIG. 2, the electrode body 15 includes a negative electrode plate 20, a positive electrode plate 30, and separators 40. The longitudinal direction of the electrode body 15 is referred to as the longitudinal direction Z. The thickness direction of the electrode body 15 is referred to as the thickness direction D. A direction intersecting the longitudinal direction Z and the thickness direction D of the electrode body 15 is referred to as the width direction W. One side of the width direction W is referred to as the first width direction W1, and the other side of the width direction W is referred to as the second width direction W2. In other words, the second width direction W2 is opposite to the first width direction W1.

The electrode body 15 is formed by rolling a stack of the negative electrode plate 20, the positive electrode plate 30, and the separators 40 about a rolling axis in the longitudinal direction Z. The rolling axis extends in the width direction W. The separators 40 are arranged between the negative electrode plate 20 and the positive electrode plate 30. Specifically, in the electrode body 15, the separator 40, the negative electrode plate 20, the separator 40, and the positive electrode plate 30 are stacked in this order.

The width direction W of the electrode body 15 coincides with the width directions of the negative electrode plate 20, the positive electrode plate 30, and the separators 40, which are in the form of strips before being rolled. The electrode body 15 is flattened in the thickness direction D. When the stack is rolled into the electrode body 15, the separator 40, the negative electrode plate 20, the separator 40, and the positive electrode plate 30 will be consistently superposed in this order in the thickness direction D.

Negative Electrode Plate 20

The negative electrode plate 20 serves as the negative electrode of the lithium-ion rechargeable battery 10.

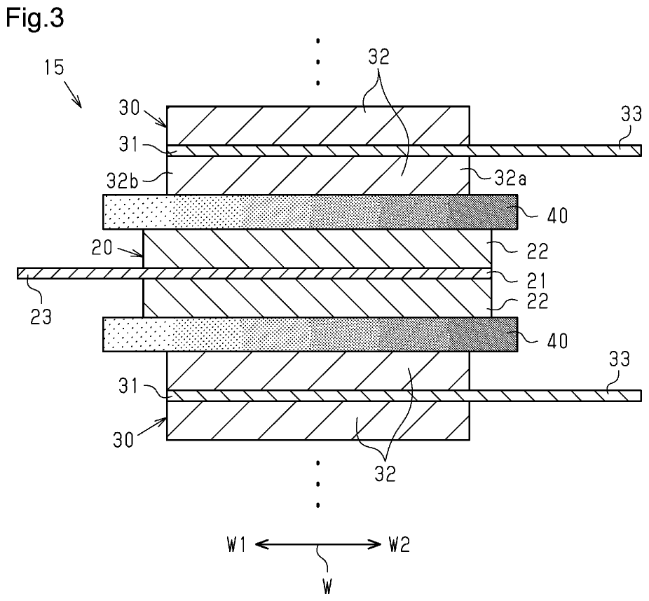

As shown in FIGS. 2 and 3, the negative electrode plate 20 includes a negative electrode substrate 21 and negative electrode mixture layers 22 applied to the surfaces of the negative electrode substrate 21. The negative electrode substrate 21 is a substrate of the negative electrode. The negative electrode mixture layers 22 are mixture layers of the negative electrode and are applied to the two surfaces of the negative electrode substrate 21.

The negative electrode substrate 21 includes a negative electrode connection portion 23. The negative electrode connection portion 23 is a region where the two surfaces of the negative electrode substrate 21 are free from the negative electrode mixture layer 22. The negative electrode connection portion 23 is arranged at the end of the electrode body 15 in the first width direction W1. In other words, the negative electrode connection portion 23 projects out of the negative electrode mixture layers 22 in the first width direction W1. The negative electrode connection portion 23 also projects outward from the positive electrode plate 30 and the separators 40 in the first width direction W1. The negative electrode connection portion 23 is connected to the negative electrode current collector 16 and thus electrically connected to the negative electrode external terminal 13.

In the present embodiment, the negative electrode substrate 21 is formed from a copper (Cu) foil. The negative electrode substrate 21 serves as a base for the negative electrode mixture layers 22. The negative electrode substrate 21 has the functionality of a current collecting member that collects electricity from the negative electrode mixture layers 22.

Each negative electrode mixture layer 22 includes a negative electrode active material and a negative electrode additive. The negative electrode plate 20 is produced by, for example, kneading the negative electrode active material and the negative electrode additive, applying the kneaded negative electrode composite material paste to the negative electrode substrate 21, and drying the negative electrode composite material paste.

The negative electrode active material is an active material of the negative electrode and has the capability to store and release lithium ions. The negative electrode active material may be, for example, a powdered carbon material such as graphite or the like.

The negative electrode additive is an additive of the negative electrode and includes a negative electrode solvent, a negative electrode binder, and a negative electrode thickener. The negative electrode solvent may be, for example, water or the like. The negative electrode binder may be, for example, styrene-butadiene rubber (SBR), polyvinylidene fluoride (PVDF), polyvinyl alcohol (PVA), or the like. The negative electrode thickener may be, for example, carboxymethyl cellulose (CMC) or the like. The negative electrode additive may further include, for example, a negative electrode conductive material or the like.

Positive Electrode Plate 30

The positive electrode plate 30 serves as the positive electrode of the lithium-ion rechargeable battery 10.

As shown in FIGS. 2 and 3, the positive electrode plate 30 includes a positive electrode substrate 31 and positive electrode mixture layers 32 applied to the surfaces of the positive electrode substrate 31. The positive electrode substrate 31 is a substrate of the positive electrode. The positive electrode mixture layers 32 are mixture layers of the positive electrode and are applied to the two surfaces of the positive electrode substrate 31.

The positive electrode substrate 31 includes a positive electrode connection portion 33. The positive electrode connection portion 33 is a region where the two surfaces of the positive electrode substrate 31 are free from the positive electrode mixture layer 32. The positive electrode connection portion 33 is arranged at the end of the electrode body 15 in the second width direction W2. In other words, the positive electrode connection portion 33 projects out of the positive electrode mixture layers 32 in the second width direction W2. The positive electrode connection portion 33 also projects outward from the negative electrode plate 20 and the separators 40 in the second width direction W2. The positive electrode connection portion 33 is connected to the positive electrode current collector 17 and thus electrically connected to the positive electrode external terminal 14. As shown in FIG. 2, the negative electrode substrate 21 includes the negative electrode connection portion 23 projecting out of the negative electrode mixture layers 22 in a first direction (corresponding to first width direction W1) of the rolling axis of the electrode body. Further, the positive electrode substrate 31 includes the positive electrode connection portion 33 projecting out of the positive electrode mixture layers 32 in a second direction (corresponding to second width direction W2) opposite to the first direction of the rolling axis of the electrode body. The positive electrode mixture layers 32 are smaller than the negative electrode mixture layers 22 in the width direction W. In other words, the negative electrode mixture layers 22 are larger than the positive electrode mixture layers 32 in the width direction W and project outward from the positive electrode mixture layers 32 in the first width direction W1 and the second width direction W2.

In the present embodiment, the positive electrode substrate 31 is formed from an aluminum (Al) foil or an Al alloy foil. The positive electrode substrate 31 serves as a base for the positive electrode mixture layers 32. The positive electrode substrate 31 has the functionality of a current collecting member that collects electricity from the positive electrode mixture layers 32.

Each positive electrode mixture layer 32 includes a positive electrode active material and a positive electrode additive. The positive electrode plate 30 is produced by, for example, kneading the positive electrode active material and the positive electrode additive, applying the kneaded positive electrode composite material paste to the positive electrode substrate 31, and drying the positive electrode composite material paste.

The positive electrode active material is an active material of the positive electrode and has the capability to store and release lithium. The positive electrode active material may be, for example, a ternary (NMC) lithium-containing composite oxide containing nickel, manganese, and cobalt, such as a lithium nickel cobalt manganese oxide (LiNiCoMnO₂). Instead, the positive electrode active material may be, for example, any one of lithium cobaltate (LiCoO₂), lithium manganate (LiMn₂O₄), and lithium nickelate (LiNiO₂). Instead, the positive electrode active material may be, for example, a lithium-containing composite oxide containing nickel, cobalt, and aluminum (NCA).

The positive electrode additive is an additive of the positive electrode and includes a positive electrode solvent, a positive electrode conductive material, and a positive electrode binder. The positive electrode solvent may be, for example, a non-aqueous solvent such as an NMP (N-methyl-2-pyrrolidone) solution. The positive electrode conductive material may be, for example, carbon fibers such as carbon nanotubes (CNT), carbon nanofibers (CNF), or the like. Alternatively, the positive electrode conductive material may be, for example, carbon black such as graphite, acetylene black (AB), Ketjen black, or the like. The positive electrode binder may be, for example, the same as the negative electrode binder. The positive electrode additive may further include, for example, a positive electrode thickener or the like.

Separator 40

The separators 40 are arranged between the negative electrode plate 20 and the positive electrode plate 30. The separators 40 are larger than the negative electrode mixture layers 22 and the positive electrode mixture layers 32 in the width direction W and project outward from the negative electrode mixture layers 22 and the positive electrode mixture layers 32 in the first width direction W1 and the second width direction W2. Each separator 40 holds the non-aqueous electrolyte 18. The separator 40 is a nonwoven fabric formed from a porous resin such as polypropylene. The separator 40 may be one of or a combination of a porous polymer film such as a porous polyethylene film, a porous polyolefin film, a porous polyvinyl chloride film, or the like, or a lithium-ion or ion-conductive polymer electrolyte film. When the electrode body 15 is immersed in the non-aqueous electrolyte 18, the non-aqueous electrolyte 18 permeates from the ends of the separators 40 toward the central portion.

Non-Aqueous Electrolyte 18

The non-aqueous electrolyte 18 is a composition in which supporting salt is contained in a non-aqueous solvent. In the present embodiment, the non-aqueous solvent may be ethylene carbonate (EC). The non-aqueous solvent may be one, two, or more types of materials selected from the group including propylene carbonate (PC), diethyl carbonate (DEC), dimethyl carbonate (DMC), ethyl methyl carbonate (EMC), and the like.

Examples of the supporting salt include LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like. The supporting salt may be one, two, or more types of lithium compounds (lithium salts) selected from the above examples. In this manner, the non-aqueous electrolyte 18 contains a lithium compound.

### Detailed Configuration of Present Embodiment

As shown in FIG. 3, each separator 40 is formed so that the portion of the separator 40 facing an end 32a of the positive electrode mixture layer 32 in the second width direction W2 has a gas permeability that is higher than that of the portion of the separator 40 facing an end 32b of the positive electrode mixture layer 32 in the first width direction W1. The gas permeability indicates the time required for the passage of a certain amount of fluid, and a greater value will mean that the passage of fluid is more restricted. The gas permeability can be increased by, for example, decreasing the porosity of the separator 40.

The separator 40 of the present embodiment is configured so that the gas permeability increases in the second width direction W2. In one example, the gas permeability of the separator 40 increases toward the end of the separator 40 in the second width direction W2 (second direction of rolling axis). The gas permeability of the separators 40 decreases toward the end of the separator 40 in the first width direction W1 (first direction of the rolling axis). Preferably, the gas permeability of the separator 40 at the end in the second width direction W2 is 105% or greater with respect to the gas permeability at the end in the first width direction W1. In the present embodiment, the gas permeability of the separator 40 at the end in the second width direction W2 is 108% or greater with respect to the gas permeability at the end in the first width direction W1. FIG. 3 schematically illustrates the varying gas permeability in a gradated manner.

The gas permeability of the separator 40 can be varied in the width direction W by, for example, applying a different tension force to the separator 40 during manufacturing. Further, the gas permeability of the separator 40 can be varied in the width direction W through, for example, differences in heating temperature, time, or the like during manufacturing.

The operation and advantages of the above embodiment will now be described.

(1) The gas permeability is high at the portion of the separator 40 facing the end 32a of the positive electrode mixture layer 32 in the second width direction W2. This reduces the replenished amount of the non-aqueous electrolyte 18 in the portion and limits the movement of lithium ions. Thus, the movement of lithium ions from the positive electrode mixture layer 32 toward the negative electrode mixture layer 22 is not concentrated at the position corresponding to the end 32a of the positive electrode mixture layer 32 in the second width direction W2 and can be dispersed toward the center in the width direction W where the temperature is high and the input properties are superior. This improves the input properties of the lithium-ion rechargeable battery 10 in a preferred manner. Also, the elution of metal from the positive electrode mixture layer 32 is limited at the end 32a of the positive electrode mixture layer 32 in the second width direction W2. Thus, the deposition of metal on the negative electrode mixture layer 22 is reduced at a position facing the end 32a of the positive electrode mixture layer 32 in the second width direction W2. This maintains, for example, the input/output properties of the lithium-ion rechargeable battery 10 in a preferred manner.

(2) The gas permeability of the separator 40 increases toward the second width direction W2. Thus, the replenished amount of the non-aqueous electrolyte 18 decreases toward the portion of the separator 40 facings the end 32a of the positive electrode mixture layer 32 in the second width W2, and movement of lithium ions will be limited. Thus, the lithium ions moving from the positive electrode mixture layer 32 toward the negative electrode mixture layer 22 will not concentrate at the position corresponding to the end 32a of the positive electrode mixture layer 32 in the second width direction W2 and will be gradually dispersed toward the center in the width direction W where the temperature is high and the input properties are superior. This improves the input properties of the lithium-ion rechargeable battery 10 in a further preferred manner. Also, the elution of metal from the positive electrode mixture layer 32 will be further effectively limited toward the end 32a of the positive electrode mixture layer 32 in the second width direction W2. Thus, the amount of deposited metal on the negative electrode mixture layer 22 will be limited at a position facing the end 32a of the positive electrode mixture layer 32 in the second width direction W2. This maintains, for example, the input/output properties of the lithium-ion rechargeable battery 10 in a further preferred manner.

(3) The gas permeability of the separator 40 at the end in the second width direction W2 is 105% or greater with respect to the gas permeability at the end in the first width direction W1. This maintains, for example, the input/output properties of the rechargeable battery 10 in a preferred manner.

The present embodiment may be modified as described below. The present embodiment and the following modifications can be combined if the combined modifications remain technically consistent with each other.

In the above-described embodiment, the separator 40 is configured so that the gas permeability increases toward the second width direction W2. However, the gas permeability of the separator 40 does not need to vary continuously if the gas permeability of one portion of the separator 40 that faces the end 32a of the positive electrode mixture layer 32 in the second width direction W2 is higher than the gas permeability of another portion of the separator 40 that faces the end 32b of the positive electrode mixture layer 32 in the first width direction W1. For example, the separator 40 may be configured so that the gas permeability increases in stages toward the second width direction W2. In one example, the separator 40 may be configured so that the gas permeability increases in stages in the entire separator 40 toward the second width direction W2. In another example, the separator 40 may be configured so that the gas permeability increases in at least three stages or more toward the second width direction W2.

In the above embodiment, the gas permeability of the separator 40 at the end in the second width direction W2 is 105% or greater with respect to the gas permeability at the end in the first width direction W1. Instead, the gas permeability of the separator 40 at the end in the second width direction W2 may be 105% or less with respect to the gas permeability at the end in the first width direction W1.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lithium-ion rechargeable battery, comprising:
a negative electrode plate including a negative electrode substrate and a negative electrode mixture layer applied to a surface of the negative electrode substrate;
a positive electrode plate including a positive electrode substrate and a positive electrode mixture layer applied to a surface of the positive electrode substrate;
a separator arranged between the negative electrode plate and the positive electrode plate; and
a non-aqueous electrolyte, wherein
the negative electrode substrate includes a negative electrode connection portion that projects from the negative electrode mixture layer in a first width direction and is electrically connected to a negative electrode external terminal,
the positive electrode substrate includes a positive electrode connection portion that projects from the positive electrode mixture layer in a second width direction opposite to the first width direction and is electrically connected to a positive electrode external terminal, and
the separator has a gas permeability that is greater at a portion facing an end of the positive electrode mixture layer in the second width direction than a portion facing an end of the positive electrode mixture layer in the first width direction.

2. The lithium-ion rechargeable battery according to claim 1, wherein the gas permeability of the separator increases in the second width direction.

3. The lithium-ion rechargeable battery according to claim 2, wherein the gas permeability of the separator at the end in the second width direction is 105% or greater with respect to the gas permeability at the end in the first width direction.
